(19) United States
(12) Patent Application Publication
(10) Pub. No.: US 2009/0278060 A1
(43) Pub. Date: Nov. 12, 2009

(54) PHOTOIRRADIATION APPARATUS, CRYSTALLIZATION APPARATUS, CRYSTALLIZATION METHOD, AND DEVICE

(76) Inventors: Yukio TANIGUCHI, Matsudo-shi (JP); Masakiyo MATSUMURA, Kamakura-shi (JP); Takahiko ENDO, Okegawa-shi (JP); Kazufumi AZUMA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/417,838

(22) Filed: Apr. 3, 2009

(30) Foreign Application Priority Data
May 9, 2008 (JP) 2008-122946

(51) Int. Cl. G21K 5/00

(52) U.S. Cl. 250/492.22; 250/492.2

(57) ABSTRACT

A photoirradiation apparatus includes an optical modulation element which phase-modulates light, an illumination system to illuminate the optical modulation element, and an imaging optical system which applies the phase-modulated light to a non-single-crystal semiconductor film to form a predetermined light intensity distribution with a strip-like repetitive region having long sides adjacent to each other. The light intensity distribution has a distribution which is downwards convex along a center line in a short side direction and a center line in a long side direction of the repetitive region. The light intensity distribution includes isointensity lines each bent to form a projection from a center of the repetitive region outward in the long side direction. A radius of curvature of an end of at least one isointensity line is not more than 0.3 μm. A pitch of the repetitive region in the short side direction is not more than 2 μm.

### CROSS-REFERENCE TO RELATED APPLICATIONS

This application is based upon and claims the benefit of priority from prior Japanese Patent Application No. 2008-122946, filed May 9, 2008, the entire contents of which are incorporated herein by reference.

### BACKGROUND OF THE INVENTION

1. Field of the Invention

The present invention relates to a photoirradiation apparatus, a crystallization apparatus, a crystallization method, and a device and, more particularly, to a technique which forms a crystallized semiconductor film by applying light having a predetermined light intensity distribution to a non-single-crystal semiconductor film.

2. Description of the Related Art

Conventionally, a thin-film-transistor (TFT) used in, e.g., a switching element which selects a display pixel of a liquid-crystal-display (LCD) is formed using amorphous-silicon or poly-silicon.

Poly-silicon has a high electron or hole mobility than amorphous-silicon. When a transistor is formed using poly-silicon, the switching speed becomes higher than that of a transistor formed using amorphous-silicon, leading to a higher display response speed. Amorphous-silicon also allows forming a peripheral LSI from a thin-film-transistor. Amorphous-silicon can also advantageously decrease the design margin of other components. When building a peripheral circuit such as a driver circuit or DAC into a display, amorphous-silicon allows the peripheral circuit to operate at a higher speed.

Poly-silicon is formed of an aggregate of crystal grains. When forming, e.g., a TFT, a grain boundary is formed in the channel region. The grain boundary serves as a barrier and decreases the electron or hole mobility to be lower than in single-crystal silicon. When a large number of thin-film-transistors are formed on a poly-silicon substrate, the number of grain boundaries formed in the channel portions differs among the respective thin-film-transistors. This leads to nonuniformities to narrow the design margin of a peripheral circuit and cause display nonuniformity of a liquid-crystal-display. Hence, recently, to improve the electron or hole mobility, a crystallization method has been proposed which forms large-grain-size crystallized silicon having a structure in which no grain boundaries exist in the carrier moving direction in the channel.

Conventionally, as a crystallization method of this type, a “phase control ELA (Excimer Laser Annealing) method” is known. According to this method, an excimer laser beam is applied to a phase shifter (optical modulation element), and a Fresnel diffraction image formed by the excimer laser beam or an image formed by an imaging optical system is applied to a non-single-crystal semiconductor film (polycrystalline semiconductor film or non-single-crystal semiconductor film), thus forming a crystallized semiconductor film. The phase control ELA method is disclosed in detail in, e.g., Journal of The Surface Science Society of Japan, Volume 21, Number 5, pp. 278 - 287, 2000.

According to the phase control ELA method, a light intensity distribution having an inverted peak pattern (e.g., a V-shaped pattern in which the light intensity is the lowest at the center and increases sharply toward the periphery) is formed in which the light intensity is lower at a point corresponding to the phase shifting portion of a phase shifter than the periphery. Light having this inverted V-shaped light intensity distribution is applied to a non-single-crystal semiconductor film. As a result, in the irradiated region, a temperature gradient is formed in a melted region in accordance with the light intensity distribution. A crystal nucleus is formed at a portion that solidifies the first to correspond to the point with the lowest light intensity, or at a portion that is not melted. The crystal grows from the crystal nucleus toward the periphery in the lateral direction (to be referred to as “lateral growth” hereinafter), thus forming single-crystal grains with large grain sizes.

The present applicant has previously proposed a technique, i.e., a one-dimensional crystallization scheme, which causes crystals to grow one-dimensionally along the gradient direction of the light intensity by applying to a non-single-crystal semiconductor film light having a light intensity distribution which changes in a V shape in one direction (the V-shaped light intensity distribution) (for example, see Jpn. Pat. Appln. KOKAI Publication No. 2004-343073).

Generally, accordingly one-dimensional crystallization of the conventional technique, grain boundaries which cause scattering extend across the carrier moving direction in a channel, as will be described later, thus decreasing the carrier mobility. Also, the crystal orientation as a factor that determines the carrier mobility differs among crystal grains, and the number of crystal grains in the channel is comparatively small. Hence, an averaging effect of crystal grains cannot be obtained sufficiently, and the mobility is not uniformed among TFTs.

### BRIEF SUMMARY OF THE INVENTION

The present invention has been made in view of the above problems, and has as its object to provide a crystallization apparatus and a crystallization method, when applied to fabrication of TFTs, which can improve the mobilities of the TFTs and uniform the mobilities among the TFTs.

In order to solve the above problems, according to the first aspect of the present invention, there is provided a photoirradiation apparatus comprising an optical modulation element which phase-modulates light, an illumination system to illuminate the optical modulation element, and an imaging optical system which applies the light phase-modulated by the optical modulation element to the non-single-crystal semiconductor film to form a predetermined light intensity distribution with a strip-like repetitive region having long sides that are adjacent to each other on the non-single-crystal semiconductor film, wherein the predetermined light intensity distribution includes a distribution which is downwards convex along a center line of the strip-like repetitive region in a short side direction and is downwards convex along a center line of the strip-like repetitive region in a long side direction, and isointensity lines each bent to form a projection from a center of the strip-like repetitive region outward in the long side direction, a radius of curvature of an end of at least one isointensity line which is bent to form the projection is not more than 0.3 μm, and a pitch of the strip-like repetitive region in the short side direction is not more than 2 μm.

According to the second aspect of the present invention, there is provided a photoirradiation apparatus comprising an optical modulation element which phase-modulates light, an illumination system to illuminate the optical modulation element, and an imaging optical system which applies the light phase-modulated by the optical modulation element to the non-single-crystal semiconductor film to form a predetermined light intensity distribution on a strip-like repetitive region having long sides that are adjacent to each other on the non-single-crystal semiconductor film, wherein the optical modulation element includes a repetitive structure in which a first strip region including element regions lining up in a long side direction of the strip-like repetitive region and a second strip region including element regions lining up in a long side direction are repeated in a short side direction of the strip-like repetitive region, and a phase of an average of a complex amplitude transmittance in the element regions differs between the first strip region and the second strip region, and a ratio of a short side of each of the first strip region and the second strip region to a radius of an Airy disc of the point spread function of the imaging optical system is larger than 0.8 and smaller than 1.2.

According to the third aspect of the present invention, there is provided a crystallization apparatus comprising a photoirradiation apparatus according to one of the first and second aspects and a stage to hold a non-single-crystal semiconductor film, wherein a crystallized semiconductor film is formed by applying light having the predetermined light intensity to a non-single-crystal semiconductor film held by the stage.

According to the fourth aspect of the present invention, there is provided a crystallization method of forming a crystallized semiconductor film by applying light having the predetermined light intensity to a non-single-crystal semiconductor film using a photoirradiation apparatus according to one of the first and second aspects.

According to the fifth aspect of the present invention, there is provided a device manufactured using one of a crystallization apparatus according to the third aspect and a crystallization method according to the fourth aspect.

According to the sixth aspect of the present invention, there is provided a method of forming a predetermined light intensity distribution with a strip-like repetitive region having long sides that are adjacent to each other on a non-single-crystal semiconductor film by applying light to the non-single-crystal semiconductor film. The predetermined light intensity distribution has a distribution which is downwards convex along a center line of the strip-like repetitive region in a short side direction and is downwards convex along a center line of the strip-like repetitive region in a long side direction, and isointensity lines each bent to form a projection from a center of the strip-like repetitive region outward in the long side direction, a radius of curvature of an end of at least one isointensity line which is bent to form the projection is not more than 0.3 μm, and a pitch of the strip-like repetitive region in the short side direction is not more than 2 μm.

With the crystallization apparatus and crystallization method of the present invention, light having a two-dimensional light intensity distribution comprising a combination of, e.g., a V-shaped distribution and a comb-like uneven distribution is applied to a non-single-crystal semiconductor film. As a result, crystal growth from crystal nuclei formed at substantially equidistantly is subdivided by the high-intensity portions (to be referred to as “ridge lines” hereinafter) of the comb-like uneven distribution. Band-like crystal grains with small widths are formed almost parallel to each other such that their long sides are adjacent.

Therefore, when a TFT is fabricated in a region comprising the band-like crystal grains formed almost parallel to each other, the grain boundaries that cause scattering do not extend across the carrier moving direction in the channel. This improves the carrier mobility. Although the crystal orientations differ among crystal grains, as the number of crystal grains in the channel becomes comparatively large, the averaging effect of the crystal grains can be obtained sufficiently. This uniforms the carrier mobilities among the TFTs. In other words, the mobility in the TFT can be improved, and the mobilities among the TFTs can be uniformed.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing random formation of crystal nuclei in conventional one-dimensional crystallization;

FIG. 2 is a view schematically showing a TFT fabricated in a region comprising crystal grains formed by conventional one-dimensional crystallization;

FIG. 3 is a view schematically showing application of light having a two-dimensional light intensity distribution comprising a combination of a V-shaped distribution and a comb-like uneven distribution to a non-single-crystal semiconductor film;

FIG. 4 is a view schematically showing formation of the two-dimensional light intensity distribution with strip-like repetitive regions having long sides that are adjacent to each other on the non-single-crystal semiconductor film;

FIG. 5 is a view schematically showing band-like crystal grains formed by subdividing crystal growth from equidistantly formed crystal nuclei with the ridge lines of the two-dimensional light intensity distribution;

FIG. 6 is a view schematically showing crystal grains formed almost parallel to each other such that long sides are adjacent to each other;

FIG. 7 is a view schematically showing a TFT fabricated in a region comprising band-like crystal grains which are formed almost parallel to each other;

FIG. 8 is a graph showing the calculation result of a comb-like uneven distribution which is formed when a ratio Ls/Rd is 0.8;

FIG. 9 is a graph showing the calculation result of a comb-like uneven distribution which is formed when the ratio Ls/Rd is 1.0;

FIG. 10 is a graph showing the calculation result of a comb-like uneven distribution which is formed when the ratio Ls/Rd is 1.2;

FIG. 11 is a view showing a model that explains a state immediately after crystal nuclei are formed;

FIG. 12 is a view showing a model that explains a state after crystals grow from the crystal nuclei;

FIG. 13 is a view showing a model that explains the radiation angle of one crystal grain;

FIG. 14 is a graph showing the relationship between a radius R of curvature of an isointensity line and a radiation angle θ of the crystal grain in the model of FIG. 13;

FIG. 15 is a view schematically showing the arrangement of a crystallization apparatus according to an embodiment of the present invention;

FIG. 16 is a view schematically showing the internal arrangement of an illumination system in FIG. 15;

FIG. 17 is a view schematically showing the arrangement of an optical modulation element according to Example 1 of the embodiment of the present invention;

FIG. 18 is a graph showing the calculation result of a light intensity distribution obtained in Example 1;

FIG. 19 is a graph showing a light intensity distribution taken along a center line X0 in FIG. 18;

FIG. 20 is a graph showing a light intensity distribution taken along a center line Y0 in FIG. 18;

FIG. 21 is a graph showing a light intensity distribution taken along a line Y1 in FIG. 18;

FIG. 22 is a graph showing a light intensity distribution taken along a center line X1 in FIG. 18;

FIG. 23 is a diagram of an SEM image showing a crystal structure actually obtained using the optical modulation element of Example 1;

FIG. 24 is a view schematically showing the arrangement of an optical modulation element according to Example 2 of the embodiment of the present invention;

FIG. 25 is a graph showing the calculation result of a light intensity distribution obtained in Example 2;

FIG. 26 is a graph showing a light intensity distribution taken along a center line X0 in FIG. 25;

FIG. 27 is a graph showing a light intensity distribution taken along a center line Y0 in FIG. 25;

FIG. 28 is a graph showing a light intensity distribution taken along a line Y1 in FIG. 25;

FIG. 29 is a graph showing a light intensity distribution taken along a center line X1 in FIG. 25; and

FIGS. 30A to 30E are sectional views showing steps in fabricating an electronic device using the crystallization apparatus according to the embodiment of the present invention.

### DETAILED DESCRIPTION OF THE INVENTION

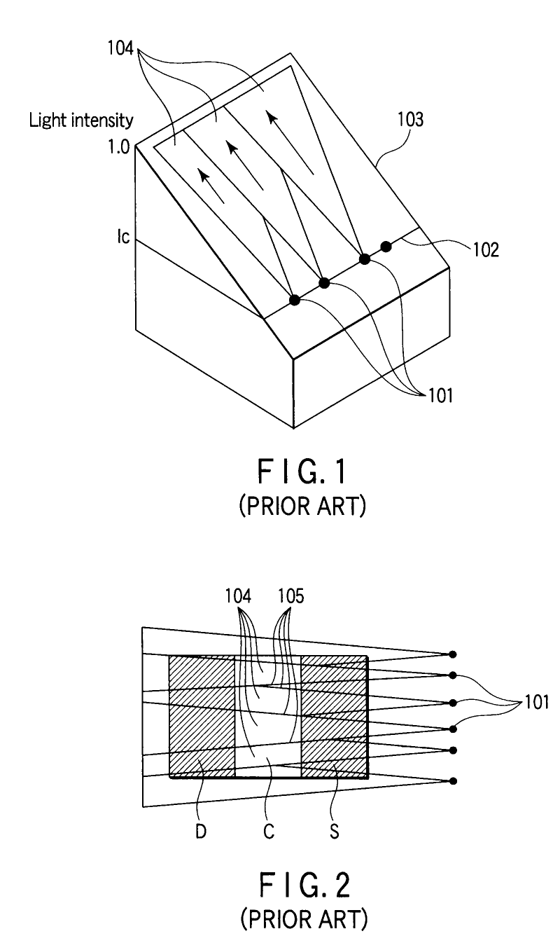

Prior to a detailed description of the embodiment of the present invention, the characteristics and inconveniences of one-dimensional crystallization in the conventional technique will be described below with reference to FIGS. 1 and 2. In conventional one-dimensional crystallization, as schematically shown in FIG. 1, crystal nuclei 101 are generated randomly on an isointensity line 102 corresponding to a critical intensity Ic. Crystal growth progresses from the crystal nuclei 101 in the direction of intensity gradient (directions indicated by arrows in FIG. 1) of a V-shaped light intensity distribution 103.

The crystal growing rate depends on the crystal orientations of the crystal nuclei 101 and differs among the crystal nuclei 101. In a region where two crystal growths meet (collide), one crystal growth that has reached the meeting point first progresses with priority over the other crystal growth. In this manner, a crystal grain 104 that has grown from the corresponding crystal nucleus 101 without interference forms a wider triangle.

Consequently, as schematically shown in FIG. 2, assume that a TFT comprising a source S, a drain D, and a channel C is fabricated in a region comprising the crystal grains 104 formed by conventional one-dimensional crystallization. Grain boundaries 105 which cause scattering extend obliquely across the carrier moving direction (horizontal direction in FIG. 2) in the channel C. Thus, the carrier mobility is decreased. The crystal orientations differ among the crystal grains 104 and the number of crystal grains 104 in the channel C is comparatively small. Thus, the averaging effect of the crystal grains 104 cannot be obtained sufficiently, and the mobilities are not uniformed among the TFTs.

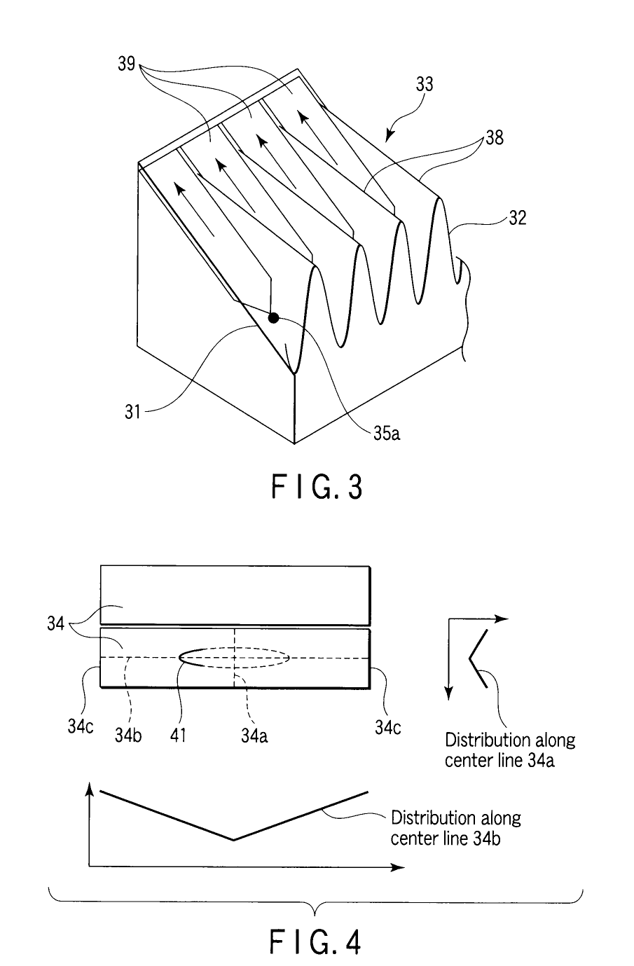

The characteristic feature of two-dimensional crystallization of the present invention will be described with reference to FIGS. 3 to 14. In two-dimensional crystallization of the present invention, as schematically shown in FIG. 3, light having a two-dimensional light intensity distribution 33 comprising a combination of a V-shaped distribution 31 and a comb-like uneven distribution 32 is applied to a non-single-crystal semiconductor film formed on, e.g., a substrate. More specifically, light which is phase-modulated by, e.g., an optical modulation element, is applied to the non-single-crystal semiconductor film through an imaging optical system to form, on the non-single-crystal semiconductor film, the two-dimensional light intensity distribution 33 in strip-like repetitive regions 34 having long sides that are adjacent to each other, as schematically shown in FIG. 4.

The two-dimensional light intensity distribution 33 has a distribution which is downwards convex along a center line 34a of the strip-like repetitive regions 34 in the short side direction and is downwards convex along a center line 34b of the strip-like repetitive regions 34 in the long side direction. In more detail, the two-dimensional light intensity distribution 33 has, for example, a V-shaped distribution along the center line 34a in the short side direction, and a V-shaped distribution along the center line 34b in the long side direction. The two-dimensional light intensity distribution 33 has a maximum light intensity at least at one point on a short side 34c of the strip-like repetitive regions 34.

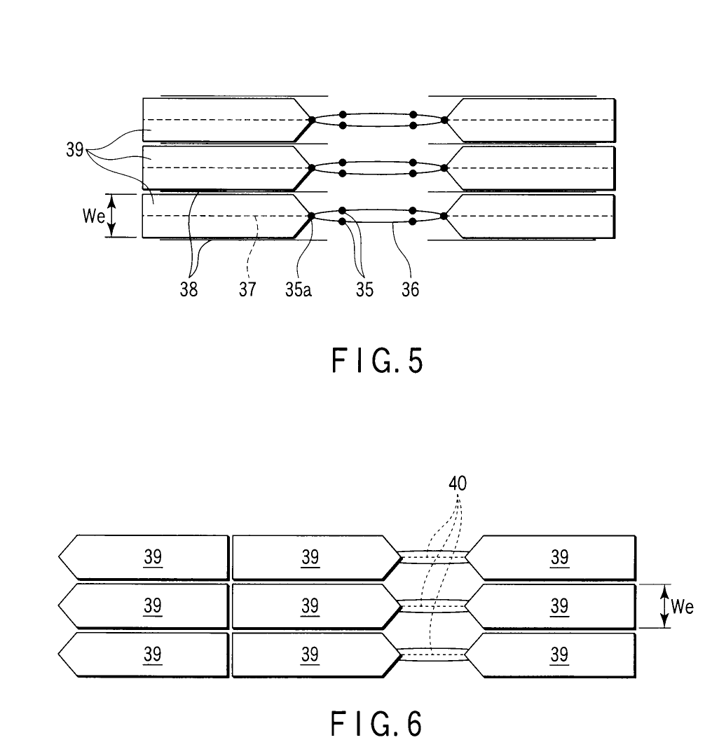

According to the present invention, crystal nuclei 35a and 35 are formed along critical intensity lines 36 of the two-dimensional light intensity distribution 33, as schematically shown in FIG. 5. The crystal nucleus 35a which is formed near the crossing of a valley line 37 and the critical intensity lines 36 of the two-dimensional light intensity distribution 33 is at the most advanced position along the direction of crystal growth. Crystal growth from this crystal nucleus 35a suppresses crystal growth from other crystal nuclei 35. Thus, the positions of the crystal nuclei 35a as the start points of crystal growth are controlled to be almost equidistant.

Crystal growth from the crystal nuclei 35a progresses in the direction along which the temperature gradient is moderate (that is, the direction along which the light intensity gradient is moderate: the directions of arrows in FIG. 3). More specifically, ridge lines 38 of the two-dimensional light intensity distribution 33 control the crystal growth from the crystal nuclei 35a not to spread toward the short sides of the strip-like repetitive regions 34, so that the crystal growth progresses to extend like bands along the long side directions of the strip-like repetitive regions 34. In this manner, crystal growth from the crystal nuclei 35a which are formed almost equidistantly is subdivided by the ridge lines 38 of the two-dimensional light intensity distribution 33. Thus, band-like crystal grains 39 with small widths We are formed.

Namely, according to the present invention, as schematically shown in FIG. 6, the pair of entirely rectangular crystal grains 39 extending like bands along the long side direction of the strip-like repetitive regions 34 are formed to sandwich a microcrystal region 40 corresponding to the critical intensity lines 36 of the two-dimensional light intensity distribution 33. The pair of crystal grains 39 are formed almost parallel to another pair of crystal grains 39, which are adjacent in the short side direction of the strip-like repetitive regions 34 and extend like bands along the long side direction of the strip-like repetitive regions 34 to sandwich another microcrystal region 40, such that the long sides are adjacent to each other.

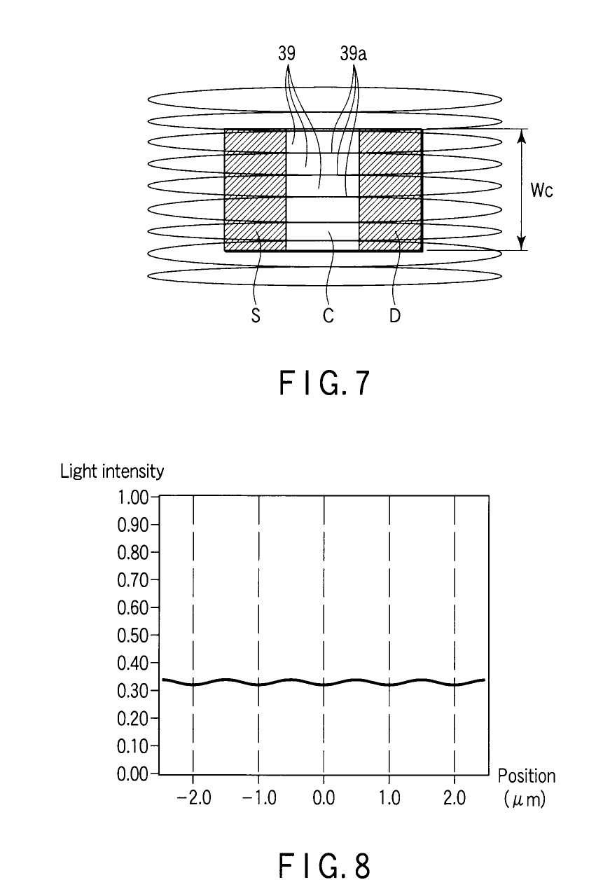

In this manner, as schematically shown in FIG. 7, assume that a TFT comprising a source S, a drain D, and a channel C is fabricated in a region comprising the band-like crystal grains 39 formed to be almost parallel to each other. Grain boundaries 39a which cause scattering do not extend across the carrier moving direction (horizontal direction in FIG. 7) in the channel C. Thus, the carrier mobility is increased. Although the crystal orientations differ among the crystal grains 39, the number of crystal grains 39 in the channel C is comparatively large. Thus, the averaging effect of the crystal grains 39 can be obtained sufficiently, and the carrier mobilities are uniformed among the TFTs.

A width Wc of the channel C of the TFT in the current liquid-crystal-display is approximately 4 μm at the smallest portion. Accordingly, to obtain the averaging effect of the crystal grains 39, desirably, the width We of each crystal grain 39 is 2 μm or less, and more desirably 1 μm or less. In other words, to obtain the averaging effect of the crystal grains 39, desirably, the pitch of the strip-like repetitive regions 34 in the short side direction is 2 μm or less, and more desirably 1 μm or less. More specifically, desirably, the number of crystal grains 39 in the channel C is approximately 2 to 4, or more.

According to the present invention, it is desirable to form the comb-like uneven distribution in the two-dimensional light intensity distribution using an optical modulation element having a phase step structure. This is because if an optical modulation element having a light-shielding film such as a chromium film is used, it is damaged by an excimer laser having a large output power. As phase modulation provides a higher resolution than amplitude modulation, the pitch of the comb-like uneven distribution can be further decreased.

FIGS. 8 to 10 show calculation results of a case in which a comb-like uneven distribution is formed by the phase step. In this calculation, a wavelength λ of light is 308 nm, and an image-side numerical aperture NA of the imaging optical system is 0.15. Hence, a radius Rd of an Airy disc of the point spread function of the imaging optical system is 1.25 μm. The Airy disc generally indicates a domain inside the innermost ring (=0) of the point spread function. If an imaging optical system is stigmatic and its pupil is circular, the domain is one inside a circle with the radius Rd given by

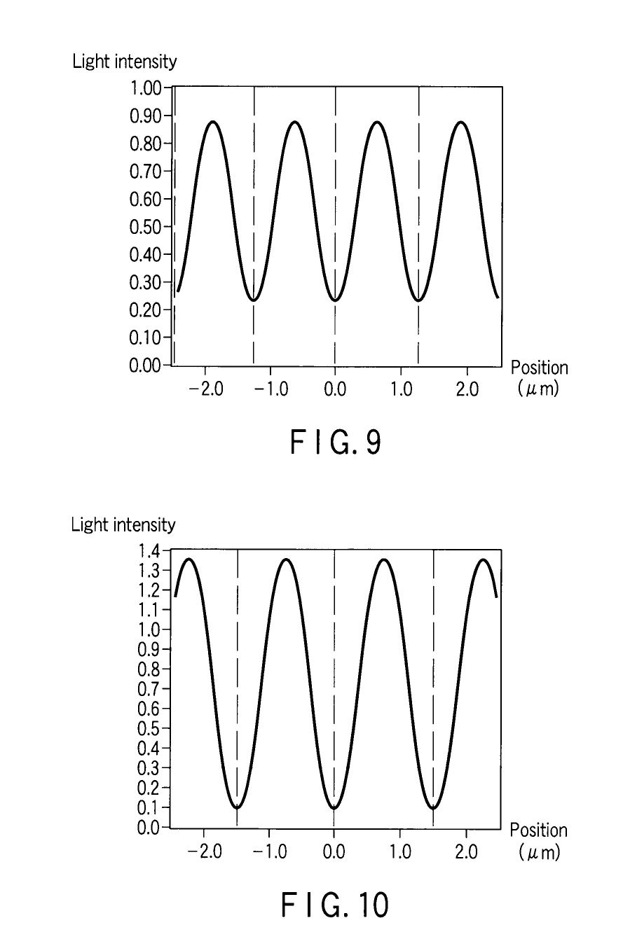

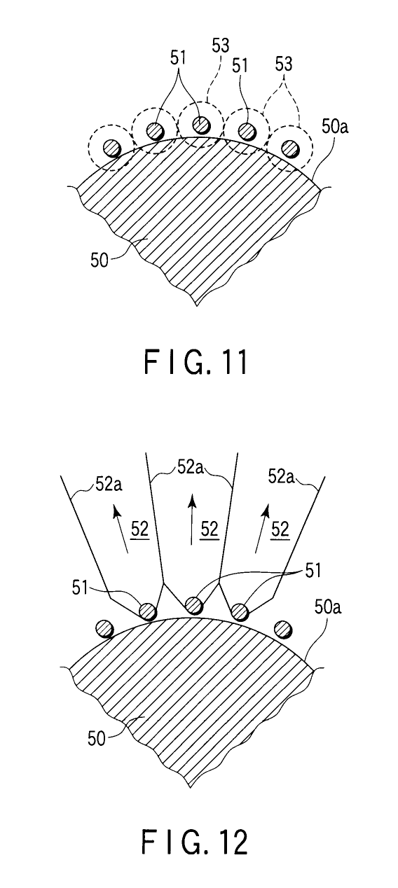

Rd=0.61λ/NA

where λ is the wavelength of a light source, and NA is the numerical aperture of the imaging optical system. In calculation, an image surface conversion size Ls of the short side of each of the strip regions (to be merely referred to as “the short side size of the phase step” as well hereinafter) is 1 μm in FIG. 8, 1.25 μm in FIG. 9, and 1.5 μm in FIG. 10.

The comb-like uneven distribution is determined by a ratio Ls/Rd of the short side size Ls of the phase step to the radius Rd of the Airy disc of the point spread function of the imaging optical system. As shown in FIG. 8, when the ratio Ls/Rd is 0.8, the amplitude of the obtained comb-like uneven distribution is excessively small, and the effect of subdividing the crystal growth cannot be exhibited. As shown in FIG. 10, when the ratio Ls/Rd is 1.2, the maximum intensity of the obtained comb-like uneven distribution exceeds 1.0, and highly possibly the Si film may break at this position. As shown in FIG. 9, when the Ls/Rd is 1.0, a comb-like uneven distribution having a desired amplitude can be obtained. Therefore, desirably, the ratio Ls/Rd is larger than 0.8 and smaller than 1.2.

As shown in FIG. 4, desirably, the two-dimensional light intensity distribution 33 according to the present invention has isointensity lines 41 each bent to form a projection from the center of the strip-like repetitive region 34 outward in the long side direction, and the radius of curvature of the end of at least one isointensity line 41 which is bent to form the projection is 0.3 μm or less. Note that the radius of curvature does not include 0. This is to allow crystal growth from the crystal nucleus 35a with a sufficiently large radiation angle. The position where crystal growth starts is 0.3 μm or less. This will be described briefly hereinafter.

Assume that light is applied to a non-single-crystal semiconductor film (amorphous-silicon) formed on a substrate. In a region irradiated with light having a light intensity lower than a value corresponding to the melting temperature (that is, a non-melted region), amorphous-silicon is not melted completely but remains non-melted at least partly. In contrast to this, in a region around the non-melted region, amorphous-silicon is melted completely. Then, the temperature of the non-single-crystal semiconductor film decreases due to heat conduction to the substrate or the like. In this process, first, crystal nuclei 51 are formed near the lowest-temperature region of the melted region, that is, near a non-melted region 50, as shown in FIG. 11.

In formation of the crystal nuclei 51, small solid grains are formed and disappear in a liquid repeatedly, and only solid grains that have reached a predetermined size become stable and form the crystal nuclei 51. After that, as shown in FIG. 12, crystals rapidly grow radially from the crystal nuclei 51 as the start points in directions indicated by arrows (in FIG. 12, crystals that grow from outer crystal nuclei 51 are not illustrated). In the formation process of the crystal nuclei 51, the following fact is known. Namely, when the crystal nuclei 51 phase-change from liquid to solid, they emit latent heat to melt nearly solid grains again. Thus, the crystal nuclei 51 are formed only at a predetermined density.

The crystal nucleus formation density is experimentally obtained in reference: J. S. Im and H. J. Kim, “Phase transformation mechanisms involved in excimer laser crystallization of amorphous-silicon films”, Appl. Phys. Lett. 63 (14), 4 Oct. 1993 (see particularly FIG. 2 of this reference). In this experiment, the grain sizes of crystals obtained when applying a XeCl excimer laser having a uniform intensity distribution to amorphous-silicon while changing the fluence (irradiation intensity) are measured.

As the result of the experiment, when light having an optimum fluence was applied at room temperature, the crystal grain sizes became approximately 0.3 μm at maximum. Considering the fact that one crystal grain grows from one crystal nucleus, the experimental result indicates that the crystal nucleus formation density corresponds to a gap of approximately 0.3 μm. This gap is determined by a microscopic phenomenon, as described above. Therefore, both of irradiation with a uniform intensity distribution as in this experiment and irradiation with a light intensity distribution having a gradient as in the present invention may be effective.

As an ordinary glass substrate used to form a liquid-crystal-display is not resistant to heat, it must be processed at room temperature. The crystal nucleus density is desirably large, as will be described later. Generally, light irradiation is performed with a fluence that can provide a maximum grain size. At this time, considering the fact that one crystal grain 52 defined by two adjacent grain boundaries 52a grows from one crystal nucleus 51 as shown in FIG. 12, the radiation angle of the crystal grain corresponds to the density of the crystal nuclei 51.

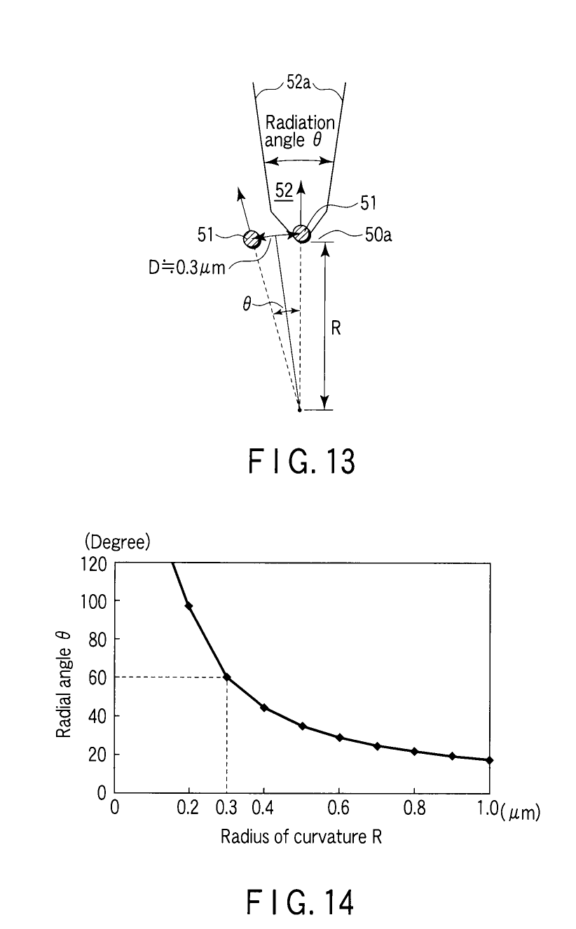

More specifically, the maximum gap of the crystal nuclei 51 obtained when the XeCl eximer laser is applied to amorphous-silicon at room temperature is approximately 0.3 μm. In other words, a gap D between the crystal nuclei 51 is approximately 0.3 μm, as shown in FIG. 13. In FIG. 11, a range with a diameter of approximately 0.3 μm about the crystal nucleus 51 as the center is indicated by a broken-line circle 53.

The crystal grains 52 grow almost radially from the crystal nucleus. A radiation angle θ (total angle) of one crystal grain 52 is obtained from a model shown in FIG. 13 in accordance with the following equation (1). In equation (1), R (unit: μm) is the radius of curvature near a given crystal nucleus 51 of the isointensity line (the isointensity line of a light intensity corresponding to the melting temperature) 50a corresponding to the outer edge of the non-melted region 50. The numerical value of 0.3 in equation (1) means 0.3 μm.

$$θ = 2 {sin}^{- 1} ( \frac{0.3}{2 R} ) \qquad ( 1 )$$

FIG. 14 is a graph showing the relationship between a radius R of curvature of an isointensity line 50a and the radiation angle θ of the crystal grain 52 in the model of FIG. 13, which is calculated from the above equation (1). Referring to FIG. 14, when the radius R of curvature of the isointensity line 50a corresponding to the outer edge of the non-melted region 50 becomes larger than 0.3 μm, the radiation angle θ of the crystal grain 52 decreases sharply.

The radiation angle θ obtained when the radius R of curvature is 0.3 μm is approximately 60°. As shown in FIG. 5, for the purpose of not to allow formation of a grain boundary in the strip region, the radiation angle θ of the crystal grain 52 is desirably approximately 60° or more. In this manner, in the present invention, to allow crystal growth with a sufficiently large radiation angle from a crystal grain, the radius of curvature of the end of the isointensity line corresponding to, e.g., the critical strength, is desirably 0.3 μm or less.

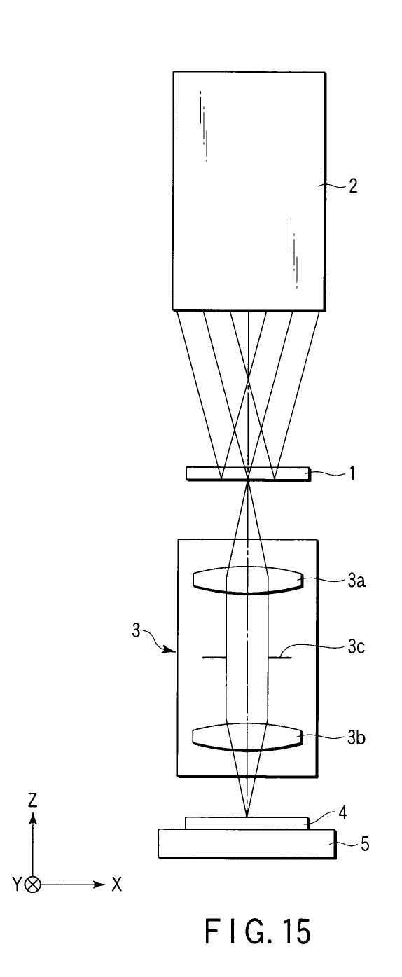

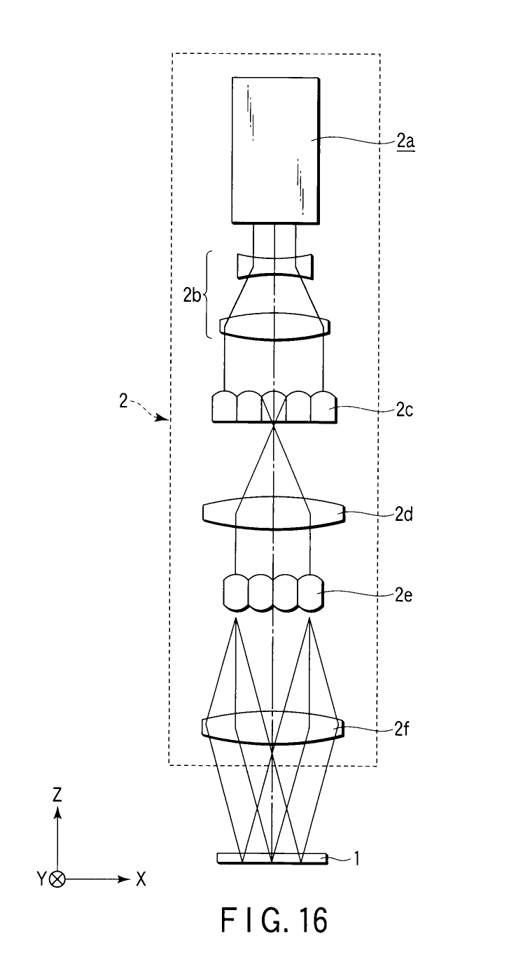

An embodiment of the present invention will be described with reference to the accompanying drawing. FIG. 15 is a view schematically showing the arrangement of a crystallization apparatus according to the embodiment of the present invention. FIG. 16 is a view schematically showing the internal arrangement of an illumination system in FIG. 15. Referring to FIGS. 15 and 16, the crystallization apparatus of this embodiment comprises an optical modulation element 1 to form light having a predetermined light intensity distribution by phase-modulating incident light, an illumination system 2 to illuminate the optical modulation element 1, an imaging optical system 3, and a substrate stage 5 to hold a processing target substrate 4.

The arrangement and function of the optical modulation element 1 will be described later. The illumination system 2 includes a XeCl excimer laser source 2a which supplies a laser beam having a wavelength of, e.g., 308 nm. As the laser source 2a, another appropriate laser source, e.g., a KrF excimer laser source or a YAG laser source, having a performance of emitting an energy beam which melts the processing target substrate 4 can be employed instead. The laser beam supplied from the laser source 2a is enlarged through a beam expander 2b and enters a first fly-eye lens 2c.

In this manner, small light sources are formed on the rear focal plane of the first fly-eye lens 2c. Beams from the small light sources illuminate the plane of incidence of a second fly-eye lens 2e in a superposing manner through a first condenser optical system 2d. As a result, more small light sources are formed on the rear focal plane of the second fly-eye lens 2e than on the rear focal plane of the first fly-eye lens 2c. Beams from the small light sources formed on the rear focal plane of the second fly-eye lens 2e illuminate the optical modulation element 1 in a superposing manner through a second condenser optical system 2f.

The first fly-eye lens 2c and first condenser optical system 2d constitute the first homogenizer. The first homogenizer uniforms the incident angle, on the optical modulation element 1, of the laser beam emitted from the laser source 2a. The second fly-eye lens 2e and second condenser optical system 2f constitute the second homogenizer. The second homogenizer uniforms the light intensities, on the respective positions on the surface of the optical modulation element 1 of the laser beams which have the uniformed incident angles and are emitted from the first homogenizer.

The laser beam which is phase-modulated by the optical modulation element 1 enters the processing target substrate 4 through the imaging optical system 3. The imaging optical system 3 allows the phase pattern plane of the optical modulation element 1 and the processing target substrate 4 to be optically conjugate with each other. In other words, the processing target substrate 4 (more strictly, the irradiation target surface of the processing target substrate 4) is set on a surface (the image surface of the imaging optical system 3) optically conjugate with the phase pattern surface of the optical modulation element 1.

For example, the imaging optical system 3 includes a positive lens group 3a, a positive lens group 3b, and an aperture diaphragm 3c arranged between the positive lens groups 3a and 3b. The size of the aperture (light-transmitting portion) of the aperture diaphragm 3c (and accordingly an image-side numerical aperture NA of the imaging optical system 3) is set to form a required light intensity distribution on the non-single-crystal semiconductor film (irradiation target surface) of the processing target substrate 4. The imaging optical system 3 may be a refraction type optical system, a reflection type optical system, or a cata-dioptic type optical system.

The imaging optical system 3 emits light phase-modulated by the optical modulation element 1 to the non-single-crystal semiconductor film of the processing target substrate 4 to form on the non-single-crystal semiconductor film 1 the two-dimensional light intensity distribution 33 with the strip-like repetitive regions 34 having long sides that are adjacent to each other.

The processing target substrate 4 is obtained by forming a lower insulating film, a non-single-crystal semiconductor film, and an upper insulating film sequentially on a substrate. In more detail, according to this embodiment, the processing target substrate 4 is obtained by forming an underlying insulating film, a non-single-crystal semiconductor film (e.g., an amorphous-silicon film), and a cap film sequentially on, e.g., a liquid-crystal-display glass sheet by chemical vapor deposition (CVD). Each of the underlying insulating film and cap film is an insulating film, e.g., an SiO₂ film. The underlying film prevents the amorphous-silicon film and glass substrate from coming into direct contact with each other, so that no foreign substance such as Na in the glass substrate may be mixed in the amorphous-silicon film, and prevents heat of the amorphous-silicon film from being directly conducted to the glass substrate.

The amorphous-silicon film is a semiconductor film to be crystallized. The cap film is heated by some light beam entering the amorphous-silicon film and stores the heat of the light beam. When the coming light beam is blocked, the high-temperature portion on the irradiation target surface of the amorphous-silicon film is cooled relatively quickly. The heat storage effect moderates this temperature drop gradient to promote lateral growth of crystals having large grain sizes. A vacuum chuck, an electrostatic chuck, or the like sets and holds the processing target substrate 4 at a predetermined position on the substrate stage 5.

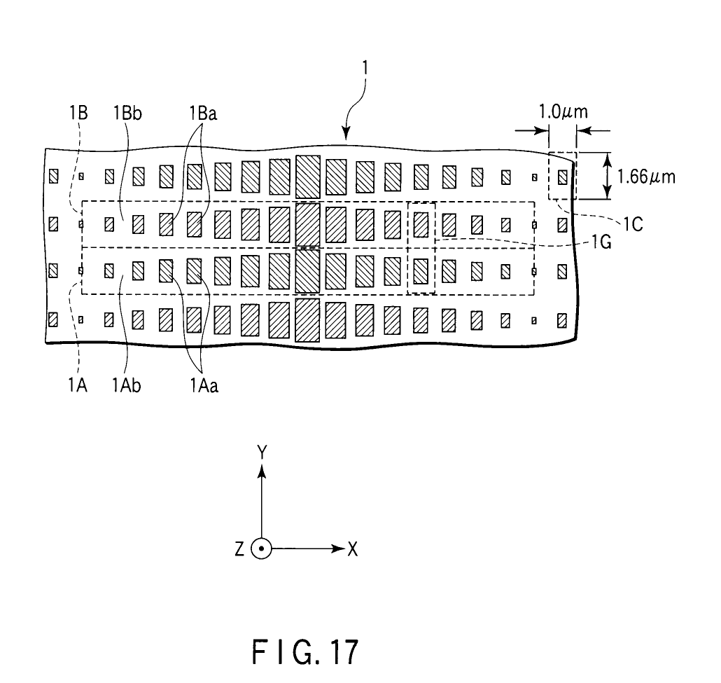

FIG. 17 is a view schematically showing the arrangement of the optical modulation element according to Example 1 of this embodiment. In FIG. 17, the X direction corresponds to the long side direction of the strip-like repetitive regions 34 described above, and the Y direction corresponds to the short side direction of the strip-like repetitive regions 34 described above. The optical modulation element 1 of Example 1 has a rectangular first strip region (a rectangular region surrounded by a broken line in FIG. 17) 1A extending long in the X direction, and a rectangular second strip region (a rectangular region surrounded by a broken line in FIG. 17) 1B extending long similarly in the Y direction. The first strip region 1A and second strip region 1B are arranged such that their long sides are adjacent to each other. A basic pattern comprising the first strip region 1A and second strip region 1B is repeatedly formed two-dimensionally in the X and Y directions.

In the first strip region 1A, a rectangular region 1Aa indicated by a hatched portion in FIG. 17 has a phase value of +90°, and a region 1Ab indicated by a hollow portion in FIG. 17 has a phase value of 0°. In the second strip region 1B, a rectangular region 1Ba indicated by a hatched portion in FIG. 17 has a phase value of −90°, and a region 1Bb indicated by a hollow portion in FIG. 17 has a phase value of 0°. Note that +90° means a phase advance of 90° from reference phase value 0°, and −90° means a phase delay of 90° from reference phase value 0°. In this specification, suppose a wavefront of the optical modulation element immediately after a plane wave enters. When the wavefront is shifted in the traveling direction of light, this region is defined as a “phase advance” region. When the wavefront is shifted to the light source side, this region is defined as a “phase delay” region.

In each of the strip regions 1A and 1B, when converted into the image surface of the imaging optical system 3, 16 rectangular cells (element regions) 1C each having a length of 1 μm in the X direction and a length of 1.66 μm in the Y direction line up in the X direction. The size of the cell 1C when converted into the image surface of the imaging optical system 3 is set to be smaller than the radius (the radius of the point image distribution range) Rd of an Airy disc of the point spread function of the imaging optical system 3.

Namely, the optical modulation element 1 has a repetitive structure in which the first strip region 1A including the element regions 1C lining up in the X direction and the second strip region 1B comprising the element regions 1C lining up in the X direction are repeated in the X and Y directions. Each element region 1C of the first strip region 1A includes the region 1Aa having the phase value of +90° and the region 1Ab having the phase value of 0°. Each element region 1C of the second strip region 1B includes the region 1Ba having the phase value of +90° and the region 1Bb having the phase value of 0°.

In the first strip region 1A, the occupied area ratio of the region 1Aa in each cell (that is, the proportion of the area occupied by the region 1Aa in each cell) changes in the X direction. More specifically, the occupied area ratio of the region 1Aa in the X direction is largest at the center of the first strip region 1A and decreases monotonically toward the two ends of the first strip region 1A.

In the second strip region 1B, the occupied area ratio of the region 1Ba in each cell (that is, the proportion of the area occupied by the region 1Ba in each cell) changes in the X direction, in the same manner as in the first strip region 1A. More specifically, the occupied area ratio of the region 1Ba in the X direction is the largest at the center of the second strip region 1B and decreases monotonically toward the two ends of the second strip region 1B, in the same manner as in the first strip region 1A.

In this manner, in the optical modulation element 1, in the region obtained by connecting the first strip region 1A and second strip region 1B, the absolute value of the average of a complex amplitude transmittance in a region (denoted by reference numeral 1G in FIG. 17) which is obtained by connecting two element regions, i.e., one element region of the first strip region 1A and one element region of the second strip region 1B, forms a downwards convex distribution in the X direction. The complex amplitude transmittance indicates the change rate of the complex amplitude when light passes through an optical modulation element. Also, the phase of the average of the complex amplitude transmittance in the region 1G obtained by connecting the two element regions, i.e., one element region of the first strip region 1A and one element region of the second strip region 1B, is different between the first strip region 1A and second strip region 1B. Namely, the phase of the average of the complex amplitude transmittance in the element region is different between the first strip region 1A and second strip region 1B.

In Example 1, the light intensity distribution to be formed on the processing target substrate 4 using the optical modulation element 1 shown in FIG. 17 is obtained by calculation. The conditions for calculation are as follows. Namely, the wavelength of light is 308 nm (0.308 μm), and the image-side numerical aperture NA of the imaging optical system 3 is 0.13. The exit-side numerical aperture of the illumination system 2 is 0.065. Hence, the coherence factor (illumination α value; (exit-side numerical aperture of the illumination system 2)/(object-side numerical aperture of the imaging optical system 3)) is 0.5 (=0.065/0.13).

The radius Rd (=0.61λ/NA) of the Airy disc of the point spread function of the imaging optical system 3 is approximately 1.45 μm. Since the image surface conversion size Ls of the short side of each of the strip regions 1A and 1B that constitute the phase step is 1.66 μm, the ratio Ls/Rd of the short side size Ls of the phase step to the radius Rd of the Airy disc of the point spread function of the imaging optical system 3 is 1.14, which is set to a value larger than 0.8 and smaller than 1.2.

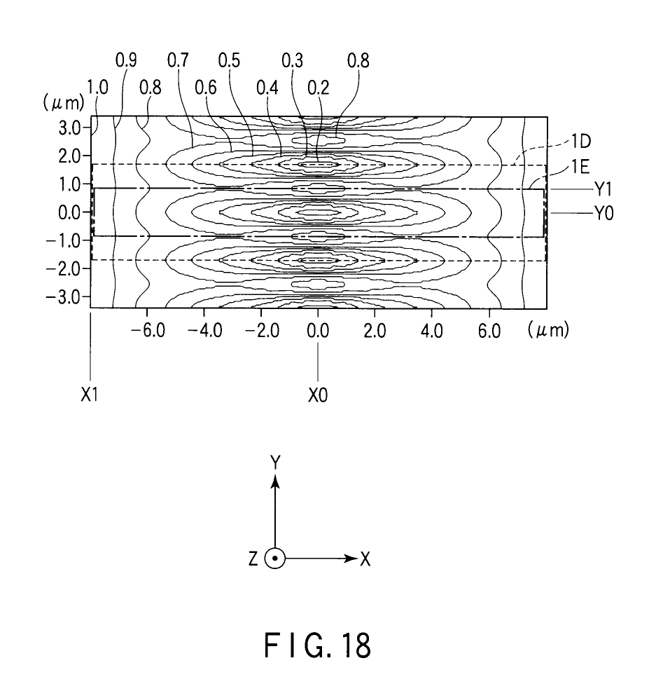

In Example 1, as the result of calculation, the light intensity distribution as shown in FIG. 18 was obtained. In FIG. 18, the light intensity distribution formed on the processing target substrate 4 using the optical modulation element 1 shown in FIG. 17 is indicated by contour lines (i.e., isointensity lines) of the light intensity. In FIG. 18, a light intensity distribution formed on the processing target substrate 4 to correspond to a basic pattern comprising the first strip region 1A and second strip region 1B of FIG. 17 is indicated by a rectangular region 1D surrounded by a broken line. A rectangular region 1E in the region 1D which is surrounded by a one-dot dashed line in FIG. 18 is the unit region of the light intensity distribution which is repeatedly formed two-dimensionally in the X and Y directions. When applying a beam with a spot of 2 mm×2 mm to the processing target substrate 4, approximately 200 to 300 unit regions 1E are repeatedly formed two-dimensionally.

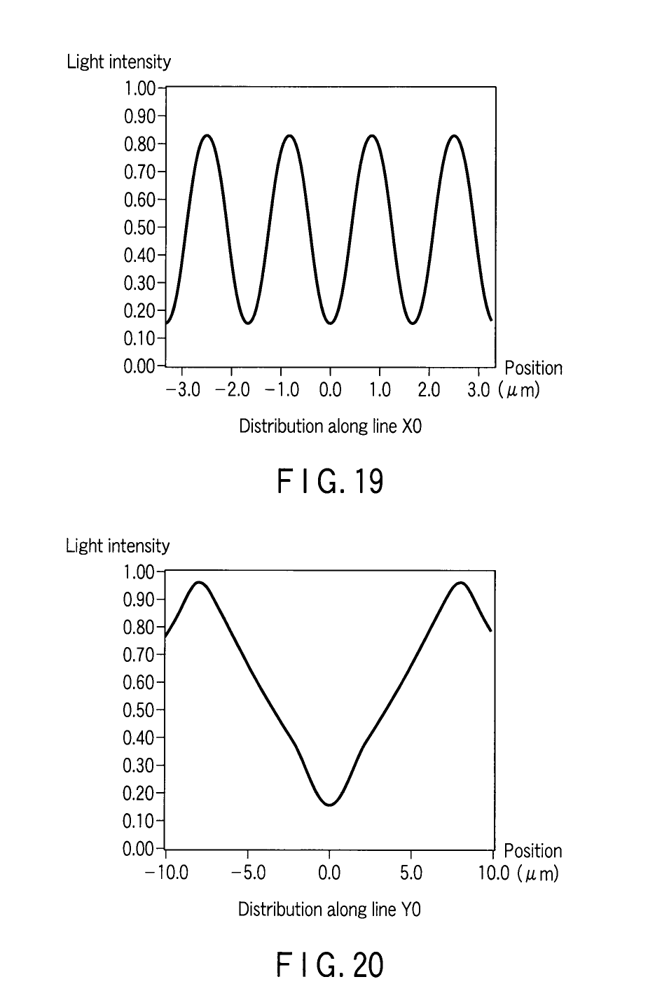

In other words, on the basis of light phase-modulated by the optical modulation element 1, a predetermined light intensity distribution is formed, on an amorphous-silicon film (non-single-crystal semiconductor film) on the processing target substrate 4, in the strip-like repetitive region 1E having long sides that are adjacent to each other. The length of the strip-like repetitive region 1E in the short side direction (Y direction) is 1.66 μm, and the length of the strip-like repetitive region 1E in the long side direction (X direction) is 16 μm. The light intensity distribution taken along a center line X0 of the strip-like repetitive region 1E in the short side direction is a downwards convex distribution, as shown in FIG. 19. Referring to FIG. 19, the downwards convex distribution is repeated in the Y direction to form a comb-like uneven distribution.

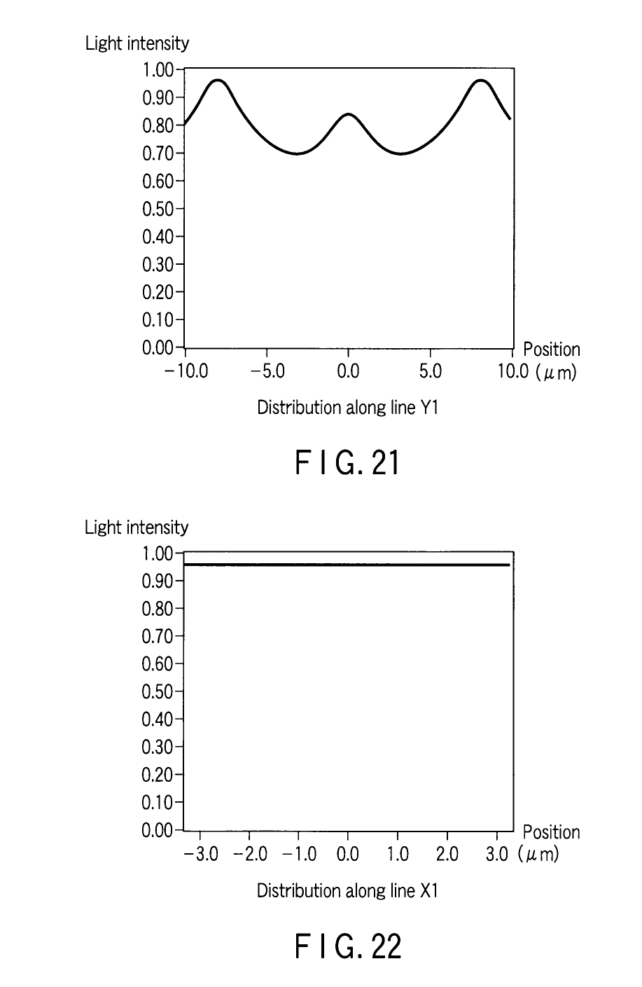

The light intensity distribution taken along a center line Y0 of the strip-like repetitive region 1E in the long side direction is a downwards convex distribution, and in more detail, a V-shaped distribution, as shown in FIG. 20. The light intensity distribution taken along a line Y1 (a position away from the center line Y0 by 1.66/2=0.83 μm in the Y direction) corresponding to the long side of the strip-like repetitive region 1E is a distribution in which a comparatively high light intensity is maintained, as shown in FIG. 21. The light intensity distribution taken along a line X1 (a position away from the center line X0 by 16/2=8 μm in the Y direction) corresponding to the short side of the strip-like repetitive region 1E is a distribution in which the maximum light intensity is maintained at a constant level (distribution having no amplitude change), as shown in FIG. 22.

In this manner, because of the operation of the effective phase step between the first strip region 1A and second strip region 1B, a downwards convex distribution is formed along the center line X0 of the strip-like repetitive region 1E in the short side direction. Also, a valley line having a downwards convex distribution (V-shaped distribution) is formed along an effective phase step line between the first strip region 1A and second strip region 1B, that is, the center line Y0 of the strip-like repetitive region 1E in the long side direction. Also, a ridge line is formed along the line Y1 corresponding to the long side of the strip-like repetitive region 1E.

In other words, the light intensity distribution formed with the strip-like repetitive region 1E by the optical modulation element 1 has a distribution which is downwards convex along the center line X0 of the region 1E in the short side direction and is downwards convex along the center line Y0 of the region 1E in the long side direction. More specifically, the light intensity distribution formed with the strip-like repetitive region 1E has a V-shaped distribution along the center line Y0 of the region 1E in the long side direction, and exhibits a maximum light intensity on the short side of the region 1E.

The pitch of the strip-like repetitive region 1E in the short side direction (Y direction) is 1.66 μm, which is set to 2 μm or less. The light intensity distribution formed with the strip-like repetitive region 1E has isointensity lines each bent to form a projection from the center of the strip-like repetitive region 1E outward in the long side direction, and the radius of curvature of the end of the isointensity line which is bent to form the projection is 0.3 μm or less.

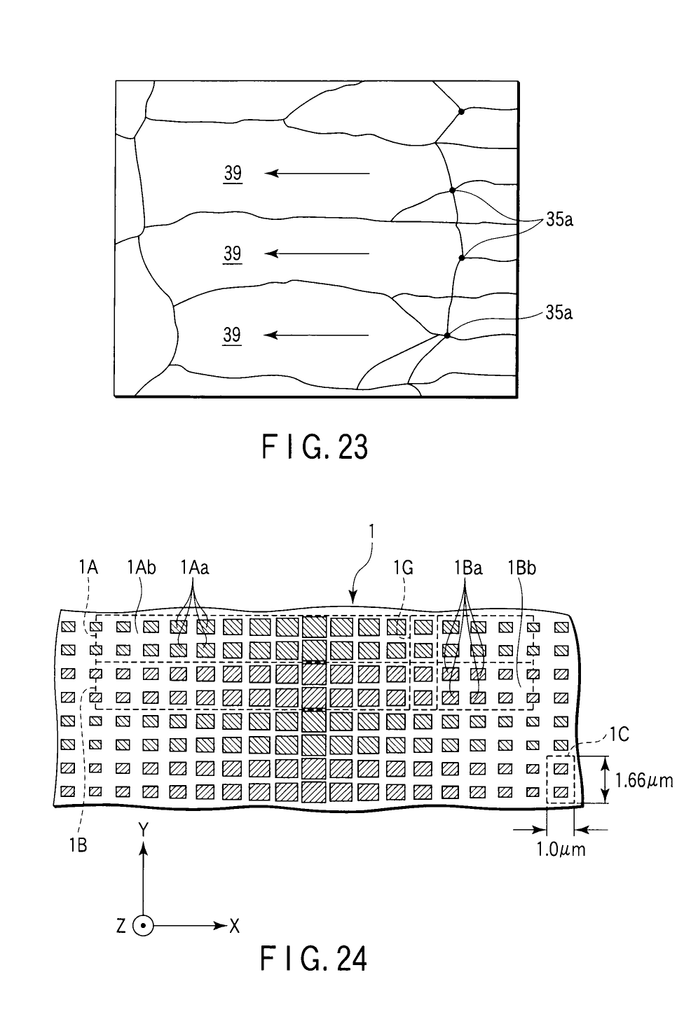

FIG. 23 is a diagram of an SEM image showing a crystal structure actually obtained using the optical modulation element 1 of Example 1. Referring to FIG. 23, reference numerals 35a denote crystal nuclei; and 39, crystal grains. The arrows indicate the direction of crystal growth. Referring to FIG. 23, crystal growth from the crystal nuclei 35a which are formed almost equidistantly is subdivided by the ridge line of the light intensity distribution. Thus, the band-like crystal grains 39 with small widths are formed almost parallel to each other such that their long sides are adjacent to each other.

FIG. 24 is a view schematically showing the arrangement of an optical modulation element according to Example 2 of the embodiment of the present invention. Example 2 employs an optical modulation element 1 having an arrangement similar to that of Example 1. Example 2 is different from Example 1 in the following respect. Namely, in each cell 1C of a first strip region 1A, two regions 1Aa each having a phase value of +90° are arranged to be spaced apart from each other in the Y direction. Also, in each cell 1C of a second strip region 1B, two regions 1Ba each having a phase value of −90° are arranged to be spaced apart from each other in the Y direction. Example 2 will be described hereinafter while paying attention to the difference from Example 1.

In the optical modulation element 1 of Example 2, the occupied area ratio of the region 1Aa in the X direction is largest at the center of the region 1A and decreases monotonically toward the two ends of the first strip region 1A. The occupied area ratio of the region 1Ba in the X direction is largest at the center of the second strip region 1B and decreases monotonically toward the two ends of the second strip region 1B. As a result, in the optical modulation element 1 of Example 2, in the same manner as in Example 1, in a region obtained by connecting the first strip region 1A and second strip region 1B, the absolute value of the average of a complex amplitude transmittance in a region (denoted by reference numeral 1G in FIG. 24) which is obtained by connecting two element regions of the first strip region 1A and two element regions of the second strip region 1B forms a downwards convex distribution in the X direction. Also, the phase of the average of the complex amplitude transmittance in the region 1G which is obtained by connecting the two element regions of the first strip region 1A and the two element regions of the second strip region 1B is different between the first strip region 1A and second strip region 1B.

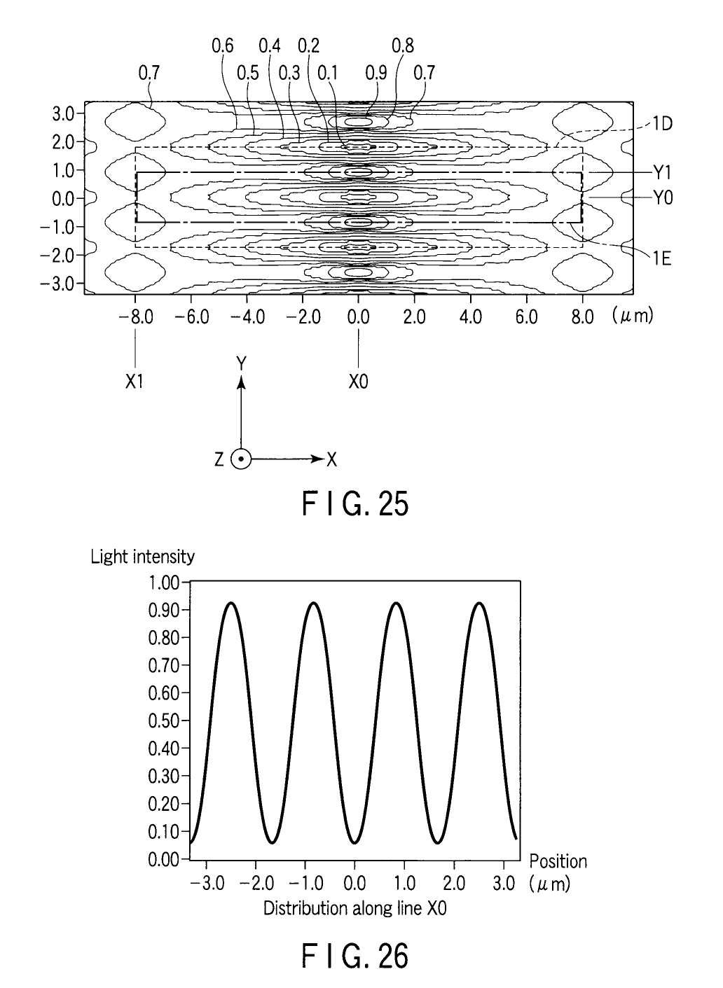

In Example 2, as the result of calculation based on the same conditions as in Example 1, a light intensity distribution as shown in FIG. 25 was obtained. In FIG. 25, the light intensity distribution formed on a processing target substrate 4 using the optical modulation element 1 shown in FIG. 24 is indicated by contour lines of the light intensity. In FIG. 25, a light intensity distribution formed to correspond to a basic pattern comprising the first strip region 1A and second strip region 1B of FIG. 24 is indicated by a region 1D, and the unit area of the light intensity distribution which is repeatedly formed two-dimensionally in the X and Y directions is indicated by a region 1E.

In Example 2, in the same manner as in Example 1, the length of the strip-like repetitive region 1E in the short side direction (Y direction) is 1.66 μm, and the length of the strip-like repetitive region 1E in the long side direction (X direction) is 16 μm. The light intensity distribution taken along a center line X0 of the strip-like repetitive region 1E in the short side direction is a downwards convex distribution, as shown in FIG. 26. Referring to FIG. 26, the downwards convex distribution is repeated in the Y direction to form a comb-like uneven distribution.

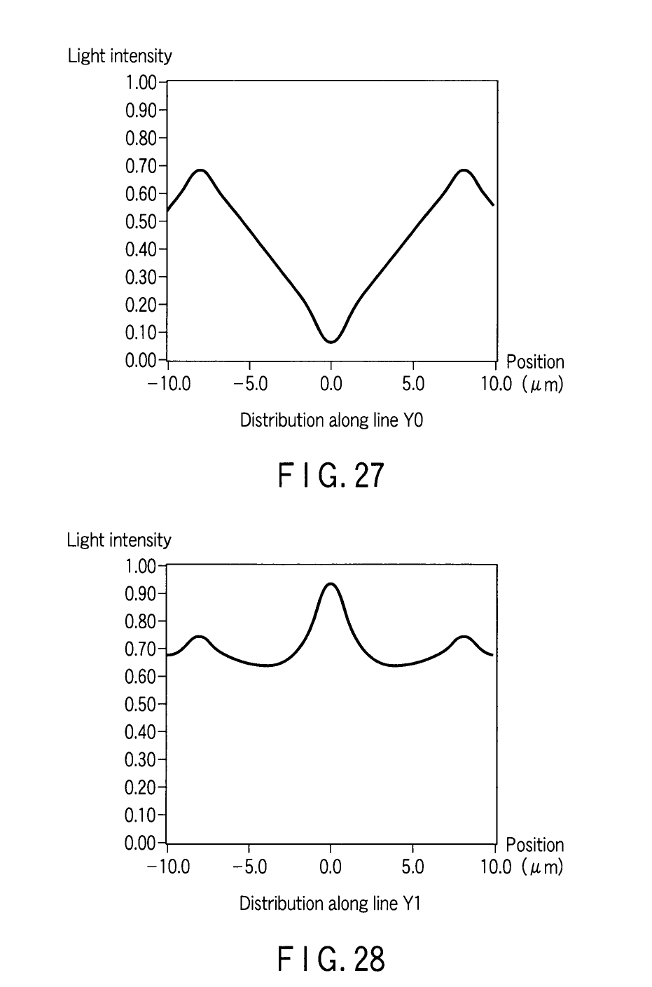

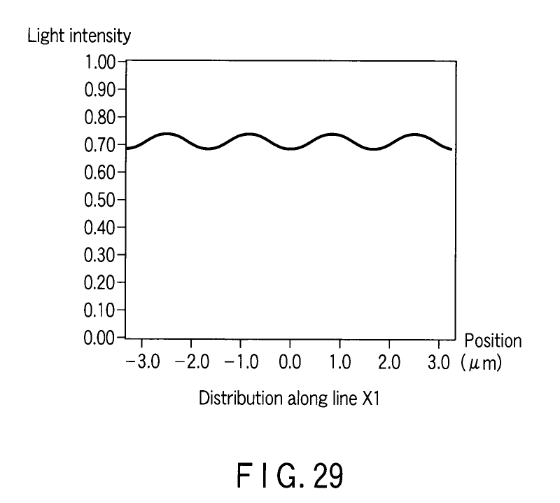

The light intensity distribution taken along a center line Y0 of the strip-like repetitive region 1E in the long side direction is a downwards convex distribution, and in more detail, a V-shaped distribution, as shown in FIG. 27. The light intensity distribution taken along a line Y1 (a position away from the center line Y0 by 1.66/2=0.83 μm in the Y direction) corresponding to the long side of the strip-like repetitive region 1E is a distribution in which a comparatively high light intensity is maintained, as shown in FIG. 28. The light intensity distribution taken along a line X1 (a position away from the center line X0 by 16/2=8 μm in the Y direction) corresponding to the short side of the strip-like repetitive region 1E is a distribution in which a change in light intensity is comparatively small (amplitude change is comparatively small), as shown in FIG. 29.

In this manner, in Example 2 as well, because of the operation of the effective phase step between the first strip region 1A and second strip region 1B, a downwards convex distribution is formed along the center line X0 of the strip-like repetitive region 1E in the short side direction. Also, a valley line having a downwards convex distribution (V-shaped distribution) is formed along an effective phase step line between the first strip region 1A and second strip region 1B, that is, the center line Y0 of the strip-like repetitive region 1E in the long side direction. Also, a ridge line is formed along the line Y1 corresponding to the long side of the strip-like repetitive region 1E.

In Example 2 as well, the pitch of the strip-like repetitive region 1E in the short side direction (Y direction) is 1.66 μm, which is set to 2 μm or less. The light intensity distribution formed with the strip-like repetitive region 1E has isointensity lines each bent to form a projection from the center of the strip-like repetitive region 1E outward in the long side direction, and the radius of curvature of the end of the isointensity line which is bent to form the projection is 0.3 μm or less. As a result, although not illustrated, a crystal structure similar to that of Example 1 could actually be obtained using the optical modulation element 1 of Example 2.

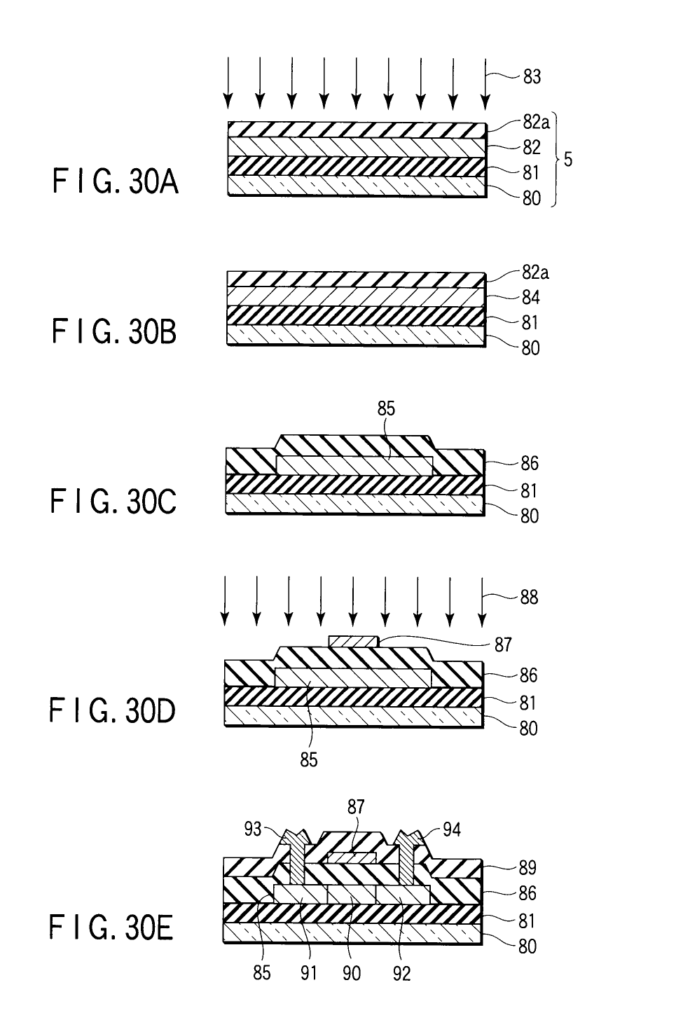

FIGS. 30A to 30E are sectional views showing steps in fabricating an electronic device in a region which is crystallized using the crystallization apparatus according to the embodiment of the present invention. As shown in FIG. 30A, a processing target substrate 4 is prepared in which an underlying film 81 (e.g., a multilayered film of 50-nm thick SiN and 100-nm thick SiO₂), an amorphous semiconductor film 82 (e.g., an Si, Ge, or SiGe semiconductor film having a thickness of approximately 50 nm to 200 nm), and a cap film 82a (not shown) (e.g., an SiO₂ film having a thickness of 30 nm to 300 nm) are formed on a transparent insulating substrate 80 (made of, e.g., alkali glass, silica glass, a plastic material, or polyimide) in accordance with chemical vapor deposition, sputtering, or the like. A laser beam 83 (e.g., a KrF excimer laser beam or XeCl excimer laser beam) is applied to a predetermined region on the surface of the amorphous semiconductor film 82 using the crystallization apparatus according to this embodiment.

In this manner, a polycrystalline semiconductor film or single-crystal semiconductor film 84 having crystals with large grain sizes is formed as shown in FIG. 30B. After removing the cap film 82a from the semiconductor film 84 by etching, the polycrystalline semiconductor film or single-crystal semiconductor film 84 is formed by photolithography into an island-like semiconductor film 85 which serves as a region on which, e.g., a thin-film-transistor is to be formed, and an SiO₂ film having a thickness of 20 nm to 100 nm is formed as a gate insulating film 86 on the surface of the resultant structure by chemical vapor deposition, sputtering, or the like, as shown in FIG. 30C. Furthermore, as shown in FIG. 30D, a gate electrode 87 (made of e.g., silicide or MoW) is formed on the gate insulating film 86. Using the gate electrode 87 as a mask, impurity ions 88 (phosphorus in the case of an N-channel transistor, and boron in the case of a P-channel transistor) are implanted in the resultant structure. After that, the resultant structure is annealed (e.g., at 450° C. for 1 hr) in a nitrogen atmosphere to activate the impurity, thus forming a source region 91 and a drain region 92 in the island-like semiconductor film 85. Then, as shown in FIG. 30E, an interlayer dielectric film 89 is formed and contact holes are formed in it, thus forming a source electrode 93 and a drain electrode 94 to be connected to a source region 91 and a drain region 92, respectively, which are connected to each other through a channel 90.

In the above process, the channel 90 is formed to be aligned with the positions of the large-size crystals of the polycrystalline or single-crystal semiconductor film 84 formed in the steps shown in FIGS. 30A and 30B, that is, at the position of a parallel strip-like crystal grain array. Through these steps, a thin-film-transistor (TFT) can be formed in the polycrystalline transistor or single-crystal semiconductor. The polycrystalline transistor or single-crystal transistor manufactured in this manner can be applied to a driving circuit for a liquid-crystal-display, an EL (electroluminescence) display, or the like, or to an integrated circuit such as a memory (SRAM or DRAM) or CPU.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A photoirradiation apparatus which applies light to a non-single-crystal semiconductor film, comprising:
an optical modulation element which phase-modulates light;
an illumination system to illuminate the optical modulation element; and
an imaging optical system which applies the light phase-modulated by the optical modulation element to the non-single-crystal semiconductor film to form a predetermined light intensity distribution with a strip-like repetitive region having long sides that are adjacent to each other on the non-single-crystal semiconductor film, wherein the predetermined light intensity distribution has a distribution which is downwards convex along a center line of the strip-like repetitive region in a short side direction and is downwards convex along a center line of the strip-like repetitive region in a long side direction, and isointensity lines each bent to form a projection from a center of the strip-like repetitive region outward in the long side direction, a radius of curvature of an end of at least one isointensity line which is bent to form the projection is not more than 0.3 μm, and a pitch of the strip-like repetitive region in the short side direction is not more than 2 μm.

2. The apparatus according to claim 1, wherein the predetermined light intensity distribution includes a V-shaped distribution along the center line in the long side direction.

3. The apparatus according to claim 1, wherein the predetermined light intensity distribution includes a maximum light intensity at least at one point on a short side of the strip-like repetitive region.

4. The apparatus according to claim 1, wherein a radius of curvature of an end of an isointensity line corresponding to an outer edge of a non-melted region irradiated with light having a light intensity not more than a value corresponding to a melting temperature of the non-single-crystal semiconductor film is not more than 0.3 μm.

5. The apparatus according to claim 1, wherein
the optical modulation element includes a repetitive structure in which a first strip region including element regions lining up in the long side direction and a second strip region including element regions lining up in the long side direction are repeated in the short side direction, and
a phase of an average of a complex amplitude transmittance in the element regions differs between the first strip region and the second strip region, and a ratio of a short side of each of the first strip region and the second strip region to a radius of an Airy disc of the point spread function of the imaging optical system is larger than 0.8 and smaller than 1.2.

6. The apparatus according to claim 5, wherein in a region obtained by connecting the first strip region and the second strip region, an absolute value of an average of a complex amplitude transmittance in a region obtained by connecting one element region of the first strip region and one element region of the second strip region forms a downwards convex distribution in a longitudinal direction of each of the respective strip regions.

7. The apparatus according to claim 6, wherein each element region of the first strip region comprises a region having a phase value of +90° and a region having a phase value of 0°, an occupied area ratio of the region having the phase value of +90° in said each element region is largest at a center of the first strip region and decreases monotonically toward two ends of the first strip region, each element region of the second strip region comprises a region having a phase value of −90° and a region having a phase value of 0°, and an occupied area ratio of the region having the phase value of −90° in said each element region is largest at a center of the second strip region and decreases monotonically toward two ends of the first strip region.

8. A photoirradiation apparatus which applies light to a non-single-crystal semiconductor film, comprising:
an optical modulation element which phase-modulates light;
an illumination system to illuminate the optical modulation element; and
an imaging optical system which applies the light phase-modulated by the optical modulation element to the non-single-crystal semiconductor film to form a predetermined light intensity distribution with a strip-like repetitive region having long sides that are adjacent to each other on the non-single-crystal semiconductor film,
wherein the optical modulation element includes a repetitive structure in which a first strip region including element regions lining up in a long side direction of the strip-like repetitive region and a second strip region including element regions lining up in a long side direction are repeated in a short side direction of the strip-like repetitive region, and
a phase of an average of a complex amplitude transmittance in the element regions differs between the first strip region and the second strip region, and a ratio of a short side of each of the first strip region and the second strip region to a radius of an Airy disc of the point spread function of the imaging optical system is larger than 0.8 and smaller than 1.2.

9. The apparatus according to claim 8, wherein in a region obtained by connecting the first strip region and the second strip region, an absolute value of an average of a complex amplitude transmittance in a region obtained by connecting one element region of the first strip region and one element region of the second strip region forms a downwards convex distribution in a longitudinal direction of each of the respective strip regions.

10. The apparatus according to claim 9, wherein each element region of the first strip region comprises a region having a phase value of +90° and a region having a phase value of 0°, an occupied area ratio of the region having the phase value of +90° in said each element region is largest at a center of the first strip region and decreases monotonically toward two ends of the first strip region, each element region of the second strip region comprises a region having a phase value of −90° and a region having a phase value of 0°, and an occupied area ratio of the region having the phase value of −90° in said each element region is largest at a center of the second strip region and decreases monotonically toward two ends of the first strip region.

11. A crystallization apparatus comprising a photoirradiation apparatus according to claim 1 and a stage to hold a non-single-crystal semiconductor film, wherein a crystallized semiconductor film is formed by applying light having the predetermined light intensity to a non-single-crystal semiconductor film held by the stage.

12. A crystallization apparatus comprising a photoirradiation apparatus according to claim 8 and a stage to hold a non-single-crystal semiconductor film, wherein a crystallized semiconductor film is formed by applying light having the predetermined light intensity to a non-single-crystal semiconductor film held by the stage.

13. A crystallization method of forming a crystallized semiconductor film by applying light having the predetermined light intensity to a non-single-crystal semiconductor film using a photoirradiation apparatus according to claim 1.

14. A crystallization method of forming a crystallized semiconductor film by applying light having the predetermined light intensity to a non-single-crystal semiconductor film using a photoirradiation apparatus according to claim 8.

15. A device manufactured using a crystallization apparatus according to claim 11.

16. A device manufactured using a crystallization apparatus according to claim 12.

17. A device manufactured using a crystallization method according to claim 13.

18. A device manufactured using a crystallization method according to claim 14.

19. A method of forming a predetermined light intensity distribution with a strip-like repetitive region having long sides that are adjacent to each other on a non-single-crystal semiconductor film by applying light to the non-single-crystal semiconductor film, wherein the predetermined light intensity distribution has a distribution which is downwards convex along a center line of the strip-like repetitive region in a short side direction and is downwards convex along a center line of the strip-like repetitive region in a long side direction, and isointensity lines each bent to form a projection from a center of the strip-like repetitive region outward in the long side direction, a radius of curvature of an end of at least one isointensity line which is bent to form the projection is not more than 0.3 μm, and a pitch of the strip-like repetitive region in the short side direction is not more than 2 μm.
